(19) United States
(12) Patent Application Publication
(10) Pub. No.: US 2023/0159744 A1
(43) Pub. Date: May 25, 2023

(54) POLYMER BLEND CRADLE FOR CABLE-STAYED BRIDGE

(71) Applicant: Felix SORKIN, Stafford, TX (US)

(72) Inventor: Felix SORKIN, Stafford, TX (US)

(21) Appl. No.: 17/993,730

(22) Filed: Nov. 23, 2022

Related U.S. Application Data
(60) Provisional application No. 63/283,060, filed on Nov. 24, 2021.

(51) Int. Cl. C08L 65/00; C08L 77/00; E01D 11/04; E01D 19/14

(52) U.S. Cl. CPC C08L 65/00; C08L 77/00; E01D 11/04; E01D 19/14

(57) ABSTRACT

A cable-stayed bridge includes a pylon, a deck, and a cable stay. The pylon may include a passage formed therethrough. The cable-stayed bridge includes a polymer blend cradle extending through the passage of the pylon. The cable stay is coupled to the deck at each end of the cable stay and passes through the passage through the pylon via the polymer blend cradle.

### TECHNICAL FIELD/FIELD OF THE DISCLOSURE

The present disclosure relates generally to structural construction components and specifically to cradles for cable stayed bridges.

### BACKGROUND OF THE DISCLOSURE

Cable-stayed bridges typically include a pylon, a deck, and one or more cable stays extending between the deck and the pylon such that the deck is supported from the pylon by the cable stays. Typical cable-stayed bridges anchor the cable stays at the deck and the pylon.

### SUMMARY

The present disclosure provides for a cable-stayed bridge. The cable-stayed bridge may include a pylon. The pylon may include a passage formed therethrough. The cable-stayed bridge may include a polymer blend cradle extending through the passage of the pylon. The cable-stayed bridge may include a deck. The cable-stayed bridge may include a cable stay. The cable stay may be coupled to the deck at each end of the cable stay. The cable stay may pass through the passage through the pylon via the polymer blend cradle.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a side elevation view of a cable-stayed bridge including a polymer blend cradle consistent with at least one embodiment of the present disclosure.

FIG. 2 is a cross-section view of the pylon of the cable-stayed bridge of FIG. 1.

FIG. 3 is a perspective view of a polymer blend cradle consistent with at least one embodiment of the present disclosure.

FIG. 4 is an end view of a polymer blend cradle consistent with at least one embodiment of the present disclosure.

FIG. 5 is an end view of a polymer blend cradle consistent with at least one embodiment of the present disclosure.

FIG. 6 is an end view of a polymer blend cradle consistent with at least one embodiment of the present disclosure.

FIG. 7 is an end vies of a polymer blend cradle consistent with at least one embodiment of the present disclosure.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

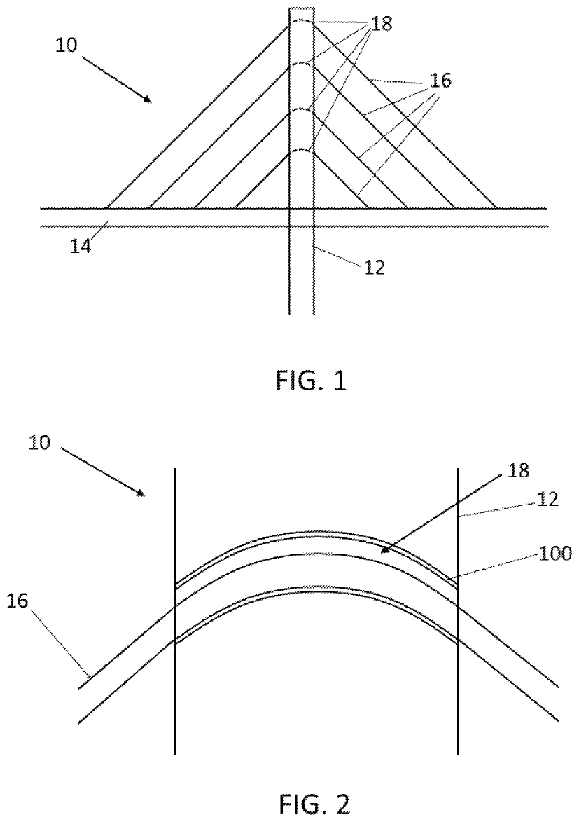

FIG. 1 depicts cable-stayed bridge 10. Cable-stayed bridge 10 may include pylon 12 and deck 14. Deck 14 may be mechanically coupled to pylon 12 by cable stays 16. In some embodiments, cable stays 16 may be anchored to deck 14. In some embodiments cable stays 16 may be anchored at each end to deck 14 and may pass through passages 18 extending through pylon 12.

In some such embodiments, as shown in FIG. 2, each passage 18 may be formed by positioning polymer blend cradle 100 through pylon 12. In an embodiment in which pylon 12 is formed from concrete, polymer blend cradle 100 may be positioned within the form for pylon 12 with the concrete poured and cast around polymer blend cable 100.

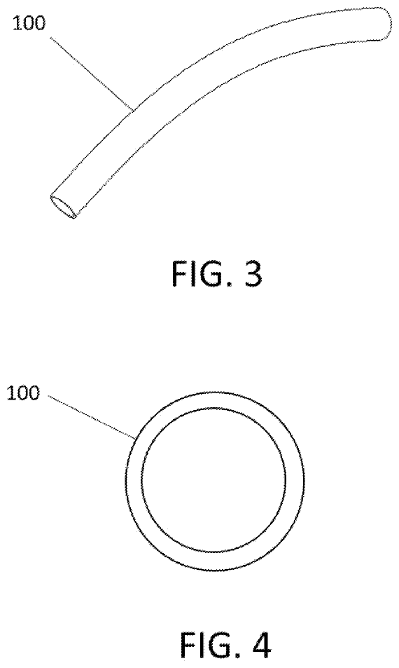

In some embodiments, as shown in FIG. 3, polymer blend cradle 100 may be tubular. In some embodiments, polymer blend cradle 100 may be arcuate in profile such that a cable stay 16 positioned therethrough enters and exits substantially straight from polymer blend cradle 100 as shown in FIG. 2. Such an arrangement may, for example and without limitation, reduce stress concentration due to bending of cable stay 16 as cable stay 16 extends through polymer blend cradle 100 when installed to cable-stayed bridge 10.

In some embodiments, polymer blend cradle 100 may be formed from a blended polymer material. By forming polymer blend cradle 100 from a selected blended polymer, the friction between cable stay 16 and polymer blend cradle 100 may be increased when compared with the friction between cable stay 16 and a metal cradle. Without being bound to theory, polymer blend cradle 100 may, for example and without limitation, deform more than a metal cradle, therefore increasing the surface area between cable stay 16 and polymer blend cradle 100 while also conforming to the outer profile of cable stay 16. Additionally, forming polymer blend cradle 100 from a blended polymer material may, for example and without limitation, reduce manufacturing costs and reduce the likelihood that corrosion of cable stay 16 occurs compared to a metal cradle. For example, by forming polymer blend cradle 100 from a non-conductive polymer, galvanic corrosion caused by dissimilar metals in cable stay 16 and a metal cradle may be prevented.

In some embodiments, polymer blend cradle 100 may be formed from a blend of one or more of polyethylene, high-density polyethylene, polypropylene, high-stiffness grades of polypropylene, and nylon. In some embodiments, polymer blend cradle 100 may be formed with glass-filled, fiber-filled, mineral bead-filled, or sand-filled polymer. In some embodiments, polymer blend cradle 100 may be at least partially formed from carbon fiber.

In some embodiments, as shown in FIG. 4, polymer blend cradle 100 may be circular in cross-section. In other embodiments, polymer blend cradle 100 may be formed such that the cross-sectional profile includes one or more friction-enhancing features.

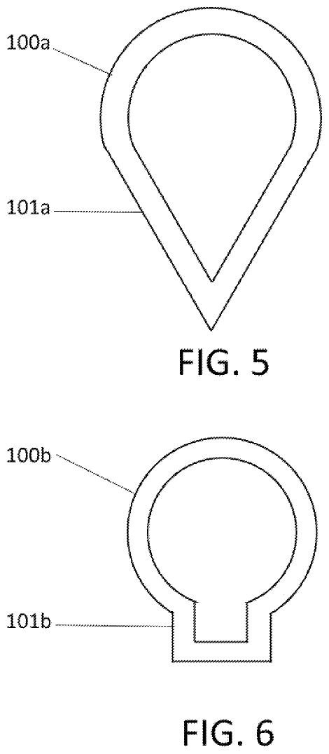

For example, FIG. 5 depicts polymer blend cradle 100a having V-shaped section 101a positioned on the concave lower surface of polymer blend cradle 100a. In such an embodiment, V-shaped section 101a may further increase the friction between polymer blend cradle 100a and cable stay 16 and further enhance the friction-increasing properties of the blended polymer material. In some embodiments, the interior of polymer blend cradle 100a may be large enough to permit cable stay 16 to pass therethrough relatively unencumbered to allow for construction of cable-stayed bridge 10. In some embodiments, as the weight of deck 14 is taken up by cable stay 16, cable stay 16 is pulled downward into V-shaped section 101a, thereby increasing the friction between polymer blend cradle 100a and cable stay 16.

As another example, FIG. 6 depicts polymer blend cradle 100b having keyway section 101b positioned on the concave lower surface of polymer blend cradle 100b. In such an embodiment, keyway section 101b may further increase the friction between polymer blend cradle 100b and cable stay 16 and further enhance the friction-increasing properties of the blended polymer material. In some embodiments, the interior of polymer blend cradle 100b may be large enough to permit cable stay 16 to pass therethrough relatively unencumbered to allow for construction of cable-stayed bridge 10. In some embodiments, as the weight of deck 14 is taken up by cable stay 16, cable stay 16 is pulled downward into keyway section 101b, thereby increasing the friction between polymer blend cradle 100b and cable stay 16.

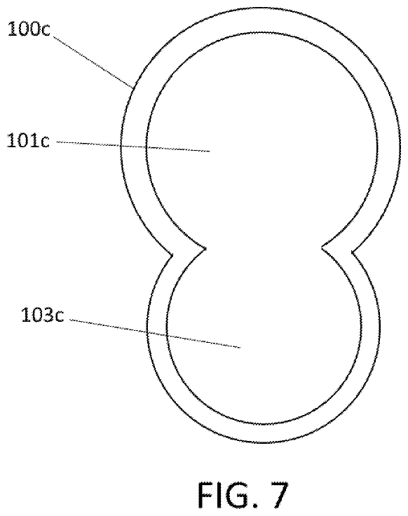

As another example, FIG. 7 depicts polymer blend cradle 100c. Polymer blend cradle 100c may have a cross-section that includes upper circular path 101c and lower circular path 103c. Upper circular path 101c and lower circular path 103c may be intersecting such that upper circular path 101c and lower circular path 103c together form the interior of polymer blend cradle 100c. In some embodiments, the diameter of upper circular path 101c may be large enough to permit cable stay 16 to pass therethrough relatively unencumbered to allow for construction of cable-stayed bridge 10. In some embodiments, the diameter of lower circular path 103c may be smaller than the diameter of upper circular path 101c such that as the weight of deck 14 is taken up by cable stay 16, cable stay 16 is pulled downward from upper circular path 101c into lower circular path 103c, thereby increasing the friction between polymer blend cradle 100c and cable stay 16.

The foregoing outlines features of several embodiments so that a person of ordinary skill in the art may better understand the aspects of the present disclosure. Such features may be replaced by any one of numerous equivalent alternatives, only some of which are disclosed herein. One of ordinary skill in the art should appreciate that they may readily use the present disclosure as a basis for designing or modifying other processes and structures for carrying out the same purposes and/or achieving the same advantages of the embodiments introduced herein. One of ordinary skill in the art should also realize that such equivalent constructions do not depart from the spirit and scope of the present disclosure and that they may make various changes, substitutions, and alterations herein without departing from the spirit and scope of the present disclosure.

1. A cable-stayed bridge comprising:
a pylon, the pylon including a passage formed therethrough;
a polymer blend cradle extending through the passage of the pylon;
a deck; and
a cable stay, the cable stay coupled to the deck at each end of the cable stay and passing through the passage through the pylon via the polymer blend cradle.

2. The cable-stayed bridge of claim 1, wherein the polymer blend cradle is formed from a blended polymer material.

3. The cable-stayed bridge of claim 2, wherein the polymer blend cradle is formed from a blend of one or more of polyethylene, high-density polyethylene, polypropylene, high-stiffness grades of polypropylene, and nylon.

4. The cable-stayed bridge of claim 2, wherein the polymer blend cradle is formed from a glass-filled, fiber-filled, mineral bead-filled, or sand-filled polymer material.

5. The cable-stayed bridge of claim 2, wherein the polymer blend cradle is at least partially formed from carbon fiber.

6. The cable-stayed bridge of claim 1, wherein the polymer blend cradle is arcuate in profile.

7. The cable-stayed bridge of claim 1, wherein the polymer blend cradle is circular in cross-section.

8. The cable-stayed bridge of claim 1, wherein the cross-section of the polymer blend cradle includes a V-shaped section.

9. The cable-stayed bridge of claim 1, wherein the cross-section of the polymer blend cradle includes a keyway section.

10. The cable-stayed bridge of claim 1, wherein the polymer blend cradle includes an upper circular path and a lower circular path, the upper and lower circular paths intersecting, the lower circular path having a diameter smaller than the diameter of the upper circular path.
